(19) United States
(12) Patent Application Publication
(10) Pub. No.: US 2012/0206256 A1
(43) Pub. Date: Aug. 16, 2012

(54) Reverse automatic warning

(76) Inventor: Harmik Isaviarktin, Burbank, CA (US)

(21) Appl. No.: 12/928,437

(22) Filed: Feb. 11, 2011

(51) Int. Cl. B60Q 1/34

(52) U.S. Cl. 340/474

(57) ABSTRACT

The Declaration of this Invention has been confirmed on Apr. 24, 2009, and filed on Feb. 20, 2011.

Reverse gear automatic warning for motor vehicles is an automatic system with alarm sound and alarm lights that work simultaneously and activates the alarm when vehicle moves backwards and deactivates the alarm when vehicle stops.

The advantages of presenting such a system and its usage will be:
1. To have an ongoing traffic
2. To let the police make the right recognition and decision in case of any accident
3. Safety for the pedestrians and the drivers in any accident
4. To have the enough vision from the sides of the car, if the light will be installed in the side of the car just like those of the rear
5. To have the sound of the horn for the pedestrians when crossing the street from the back of the car

The above system is acting automatically. In case the driver forgets to turn on the flasher or horn, the system will be turned on automatically and start working.

### TECHNICAL DESCRIPTION OF THE INVENTION

This invention is considered to be used in the Vehicle Industry.

This is a completely new technology and no article has been published in this regard.

Description of the System: The light and alarm for vehicle reverse gear—Vehicle is in the reverse gear and reverse gear light is on.

But it is not apparent whether the vehicle is stopped of moving. You can not decide whether to wait, change direction, adjust your distance, or move. Different individuals make different decisions under the similar circumstances. If, however, in addition to the reverse gear light and vehicle reverse warning alarm, these warning signals remain off while stopped, but turn on automatically at the time of vehicle moving to show that the vehicle is in motion or not, this problem will be solved.

The drivers and pedestrians can have similar decisions under similar circumstances whether to move or to maintain distance. This way the view vacuum will be filled.

Especially for the vehicles without rear view, drivers without sufficient view, the ones that become affixed on light, or become indifferent to exercise caution.

If they are warned, they will become cautious. They can not exercise, however; beforehand.

When the gear is on reverse the rear top lights are on and when the car starts to go reverse, the bottom rear lights start to blink. But when the car stops going in reverse, the blinking lights stop. This can be used on one light with two contacts also.

The invention is composed of:
1. Electronic Flasher
2. Control Box that works with a lever for connecting/disconnecting the negative
3. Control Box that works with gear wheel
4. Fuse
5. Wire
6. Wire Head
7. Light or bulb two pieces
8. Horn (alarm)
9. Base for first and second box control which connects the gear wheel to the gears over the hub
10. Terminal

Performance: The current (electricity) connects directly to the positive electronic flasher input jack, and in between that positive wire, the fuse, the on/off electricity output is connected to the warning light and warning horn.

The negative of the light and horn are connected to the body.

The negative of the electronic flasher is taken from the body and goes to the control box that works with a lever.

With the movement of the rear wheels, the gears over the hub rotate and connect the lever box control.

Through this, the negative from the wire of lever control box reaches the second control box.

The second rotating control box is connected with the gear to the circular gear located on the rear wheel hub.

At the time of rotation of the hub, the box control becomes active and delivers the negative current through negative wire to electronic flasher and activates it.

Through the out of the electronic flasher the current turns On/Off and reaches the light and the horn and activates them and initiates warning.

At vehicle stopping, the control box disconnects, the negative disconnects, the flasher stops working, and the light and alarm turn off.

By this, the negative, at the time of moving, reaches the electronic flashers negative from the second box control and wither activates or disconnects it.

Gas Pedal Method: The reverse gear wire is connected to the flasher and the positive wire comes directly from the battery and is connected to the switch underneath the gas pedal.

By pressing down the gas pedal the switch is closed and is active and electricity reaches to the flasher bulbs in a way that negative wire of the reverse gear and positive wire of the switch reach the flasher instantaneously and flasher gets activated. In this way the lights and the alarm alerts.

The On/Off control box with lever is better than the On/Off switch under the gas pedal and I chose the On/Off control box with lever.

Replacement for the Hub: In the vehicles that do not have hubs and instead have fixed plates, the control boxes can be installed over the differential.

They are installed in a way that the control box with lever and gear wheel of the second control box are installed over the differential and become active with the rotation of the axle gear.

First Stage Box Controls' Replacement—The switch in under the gas pedal. Pressing downward the positive connects and at the time of release moving upward the positive disconnects.

Negative will reach the flasher through reverse gear wire and the flasher is activated simultaneously by entering the positive wire from the switch under the gas pedal.

The first stage Box Control—The first stage Box Control that disconnects at the stopping position and becomes active at moving.

With the rotation of the lever to the back it connects and with forward rotation it disconnects.

The Second Stage Rotating Gear Wheel—The second stage Box Control is in case in the stop position the lever stays fixed, the negative remains connected and must move forward to disconnect.

The gear wheel is more sensitive and with the slightest rotation is connected and disconnected.

For the purpose of negative connect and disconnect the second stage rotating gear wheel is used and visa versa.

At the time of active rotation it allows the negative through and at the time of stopping it disconnects.

System elements assembly:
1. Positive current
2. Fuse
3. Electronic Flasher
4. On/Off current or warning
5. Terminal of splitter
6. Negative body
7. Reverse warning light
8. Reverse warning horn
9. Negative output, second stage
10. Rotating gear wheel
11. Second Stage Box Control
12. Negative wire
13. First Stage Box Control
14. Base
15. Negative body wire
16. Lever
17. Differential
18. Gear wheel
19. Hub

The first control box is for conversion of mechanical power to energy.

The second control box is to make sure of proper operation of the first box.

In the hub system, the gear wheels of the control boxes are rotating on the gear wheels of the hub. In the differential installation method, the gear wheels of the control boxes will be installed on the axel grooves and will rotate by its movement.

### THE DESCRIPTION OF CHARACTERISTICS OF THE INVENTION

The blinking light and automatic horn in the rear of the vehicle (behind the vehicle warning) is a new work that has more utility compared to the older one, or it is the first work of its kind.

The reverse gear light only shows that the vehicle is in the reverse gear. But by adding behind the vehicle warning, it shows in addition to being in the reverse gear, the vehicle is in motion.

Besides the advantages brought above:
1. Makes police job easier
2. We move a step forward in traffic signs
3. Accident prevention
4. Creation or proper order
5. Prevention of bodily and property damages
6. Driver's peace of mind
7. Vehicle safety
8. Simple and cheap to make
9. In shifting to the reverse gear, the drivers can announce their movement, honk, or use the flasher, but no one does that. Or honk horn steadily.
10. However; with installation of the vehicle reverse warning in motion that works automatically, warns by light and warning sound, and turns off when the vehicle stops, this can be eliminated.

This invention has not publicly used, offered for sale, sold in the United States or anywhere else, in any form (even if not finalized) by me or anyone else.

This invention has not been described in writing that was distributed or accessible anywhere in the world in any form by me or anyone else.

### THE DESCRIPTION OF DETAILS OF THE CONCEPT

First Box Control: FIG. 3 is the first Box Control is located in a plastic box that has a lever in it. And from the other side is connected t the plastic that has no electricity.

FIG. 3 Across from it, there is a metal connected to the negative wire and there are springs on both sides of the lever which keep the lever in balance.

FIG. 3 When we want to do disconnect, the lever is connected to the plastic through the pressure from springs.

FIG. 3 Nevertheless, when the lever becomes engaged, it exerts pressure on the springs so that the lever touches the negative metal in front.

FIG. 3 Through this way the negative current reaches from the lever to the negative wire metal.

FIG. 4 There is a gear in the second Box Control. In order to hold the gear wheel, there is a holding rod in the middle of it.

FIG. 4 From the left side, the gear is connected with a metal spring that on one end, meaning under it, is a plastic, and above it a metal for connection to the negative.

FIG. 4 Similarly on the right side, too, there is a spring that its upper head has a plastic, and on the bottom is a negative spring for the negative connection.

FIG. 4 The negative wire enters the Box Control from the left, passing on the side of the gear reaches the right spring and following connection to the right, and it subsequently exits the Box Control reaching the system.

FIG. 4 The plastics on the both sides of the metal springs prevents them touching the gear wheel and not allow the negative current to pass through when the vehicle moves forward.

FIG. 4 When moving backward, by rotation of the gear wheels the both sides of the metal springs are connected and the negative will pass through the Box Control and reaches the system.

The Box Control on the differential functions through connecting to the grooves of the axle in a way described before.

FIG. 5 The pipe which on the one side is connected to differential and on the other side, under the body where a negative wire passes through it and reaches the system.

The wiring method inside the vehicle which is in the method of utilizing gas pedal in place of mechanical power.

FIG. 2 Total wiring method for gas pedal.

### Explanation Regarding Details with Priority

### Lights Turning On Positions

First Position: The lights that are installed on the stand under the upper lights and in case of moving backward turn on and off.

FIG. 6 Second Position: The lights are installed in the Reverse Gear Lights in a way that the lights of the first contact of reverse gear are on, and the lights second contact is connected to the system.

FIG. 6 The lights work concurrently in the blinking mode in such a way that if you look at the light, one light is in a constant lighting position and the other in the blinking mode.

FIG. 10 Both lights are installed in one light, so in the reverse position, the reverse gear light does not turn off and light becomes weak and strong.

Third Position: Two lights are installed on the back of the vehicle, and the lights at the both left and right sides of the vehicle bumpers are in a way that if one wants to pass by the car will notice lights turning on the sides.

Since there is a vision vacuum, the drivers can not determine whether to pass at behind of the vehicle or not. The priority is with the second and third situations.

If the vehicle is not in reverse gear or the gas pedal is not pressed, the system will not operate.

If the system becomes defective, it will cause no short circuit to the vehicle.

The lights are white and two are installed above the vehicle bumper.

The control boxes one and two can work separately and activate the system.

During the turning of gear on the axel, the negative reaches the axel from the body and subsequently to the wires.

If switch is installed separately, the first and second control box will receive the negative from axel and deliver the negative current to the system by means of the negative outlet.

FIG. 1 Negative wires are marked as (−)

FIG. 1 Positive wires that electricity passes through them are marked (+)

### Elements of Reverse Gear Automatic Warning

1. Primary and Secondary Switches
2. Plastic Box
3. Lever
4. Spring
5. Exiting Negative wire
6. The Metal piece
7. Metal Spring
8. Lever that keeps the gear
9. Entering Negative Wire
10. Negative Metal
11. Plastic (Non Conductive Separator)
12. Negative Wire Connected to Both Sides for Negative Connect
13. Rotating Gear Wheel
   Differential and its Axis with Primary and Secondary Control Boxes
1. Axle
2. Screw
3. Differential
4. Grooves on the Axle where the Lever and the Switch connect to it
5. Primary Control Box
6. Secondary Control Box

### Statement

To whom it may concern;

We have added a new description with new diagrams for your considerations.

### DRAWINGS DESCRIPTIONS

FIG. 1. System Plan—System Plan for Design

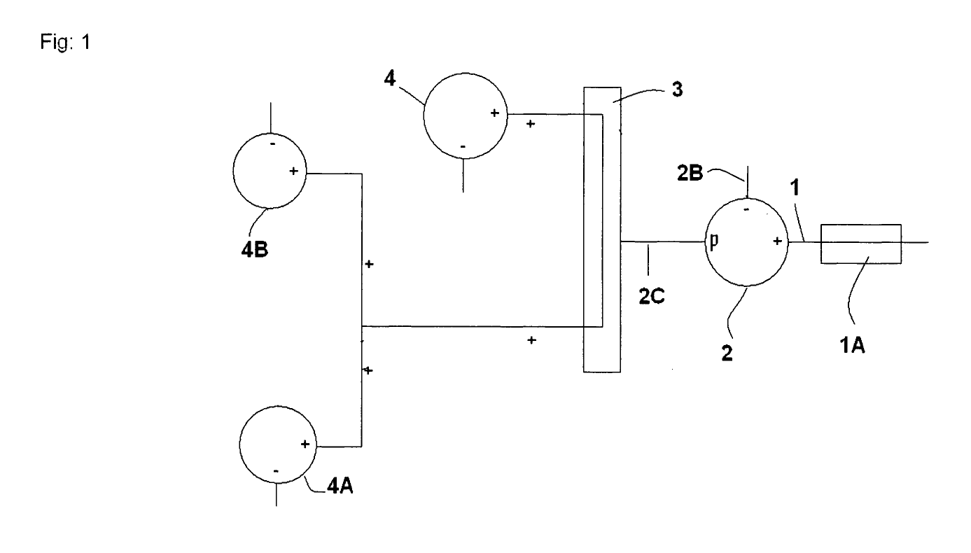

FIG. 2. Gas Pedal Method Plan—System Plan for Gas Pedal Method Design

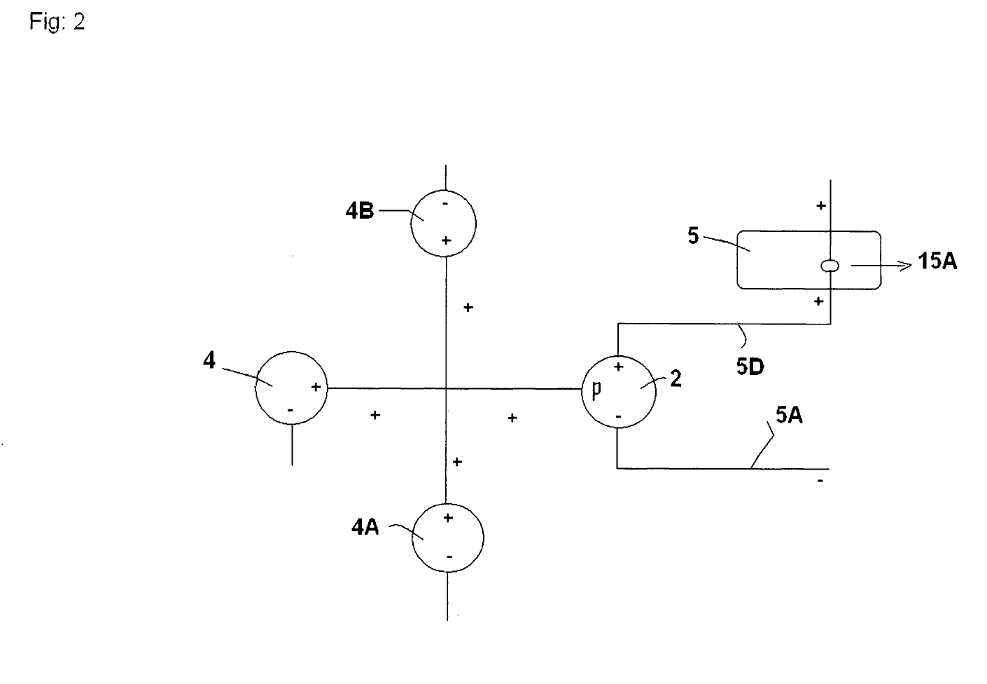

FIG. 3. First Control Box—For Gyration Force Use

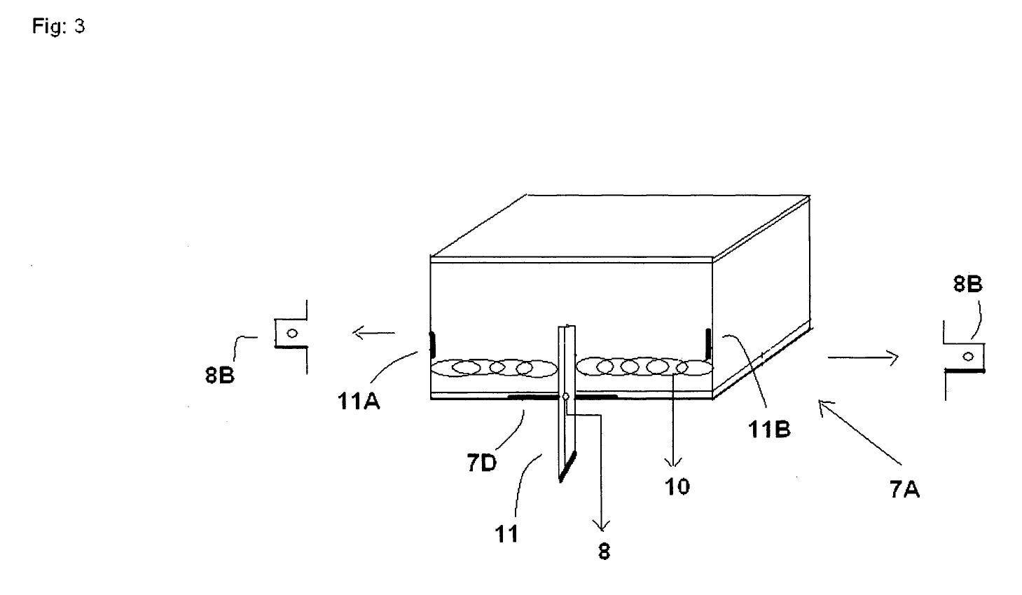

FIG. 4. Second Control Box—For Gyration Use and Assurance

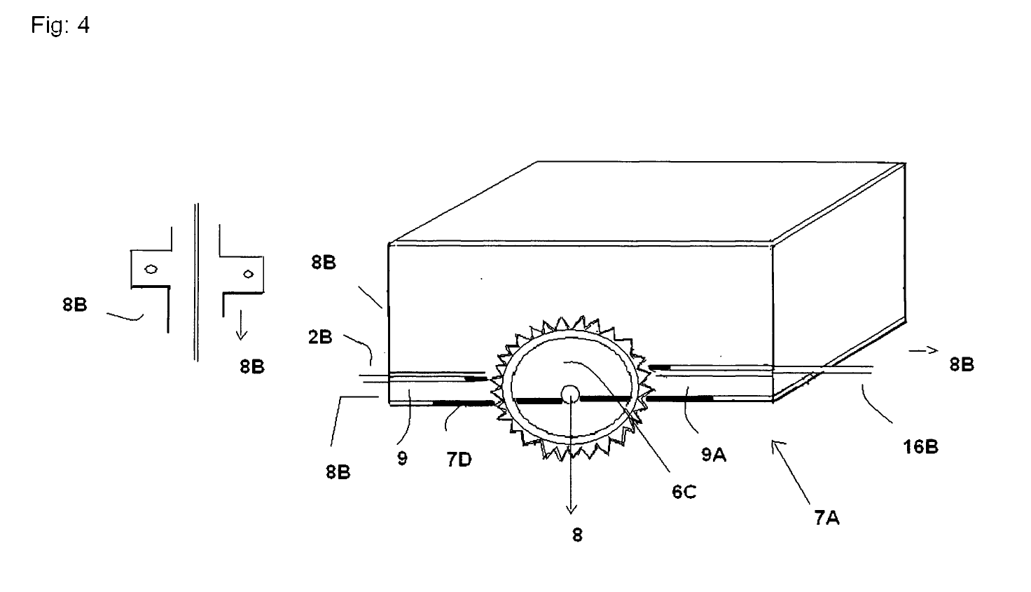

FIG. 5. Plastic Pipe—For Wire Protection

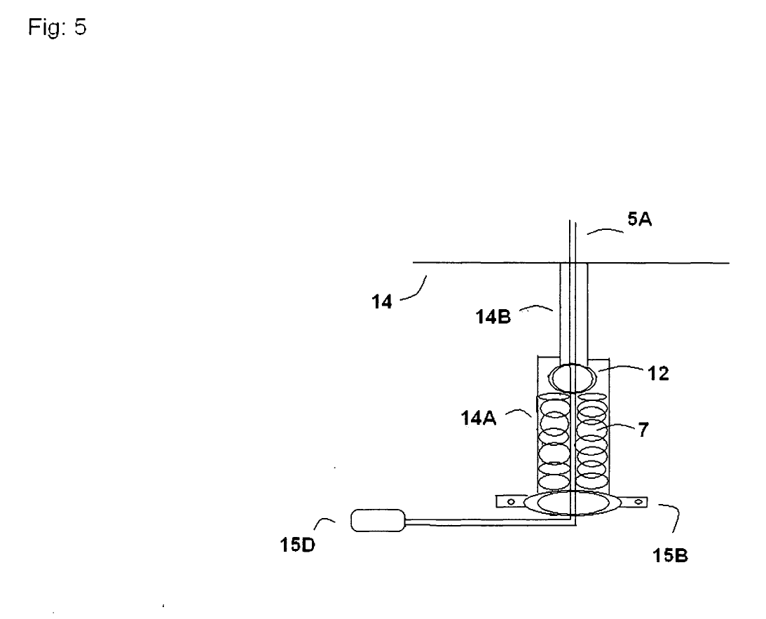

FIG. 6. Reverse Gear Light—For Use of its Light

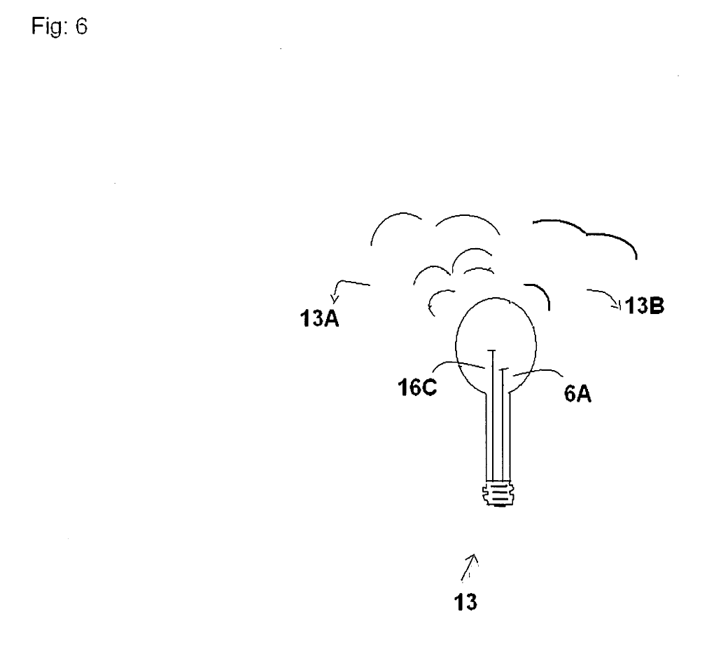

FIG. 7. Gas Pedal Method wiring—Wiring Method

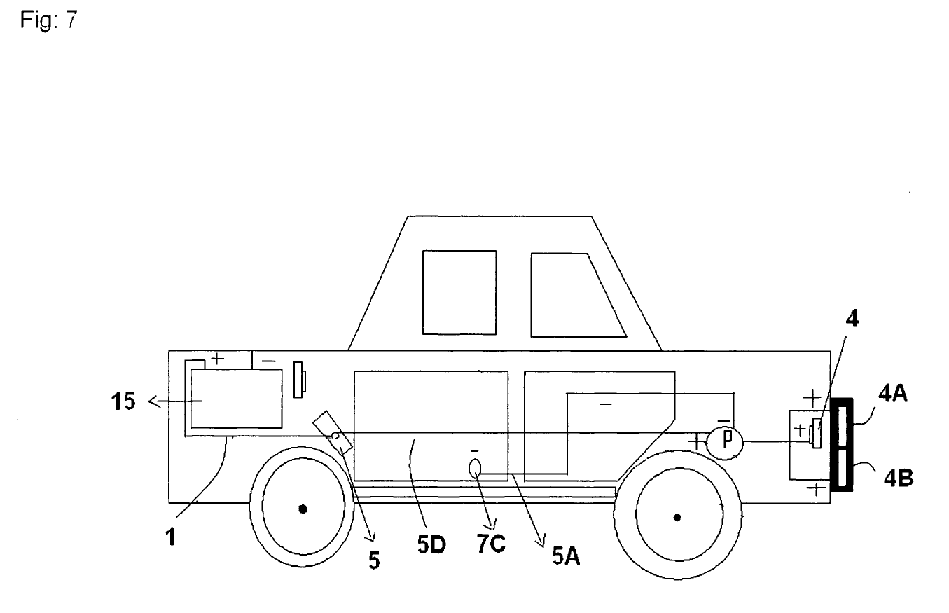

FIG. 8. Rear Wheel Hub—To Use Gyration Force

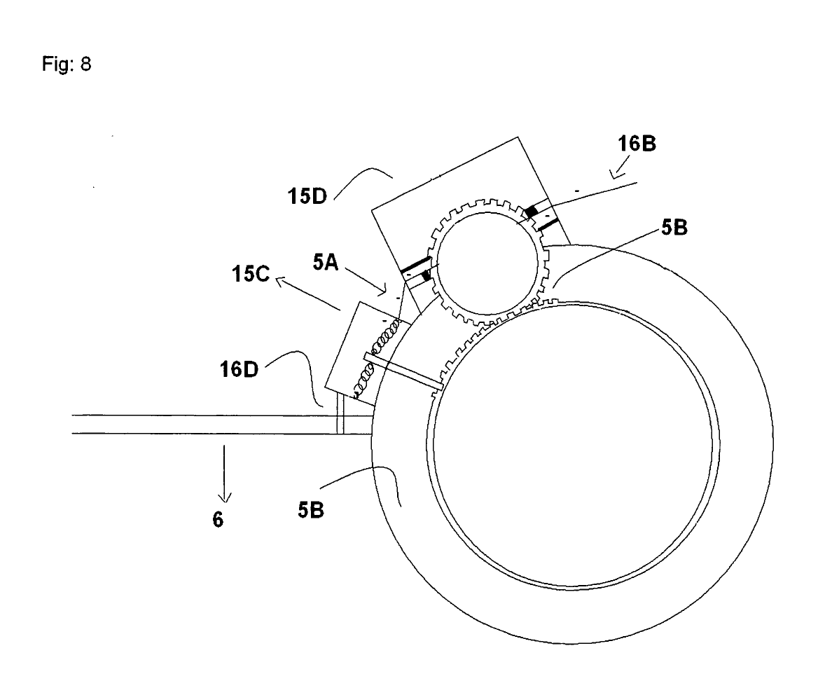

FIG. 9. Differential—To Install Boxes Controls

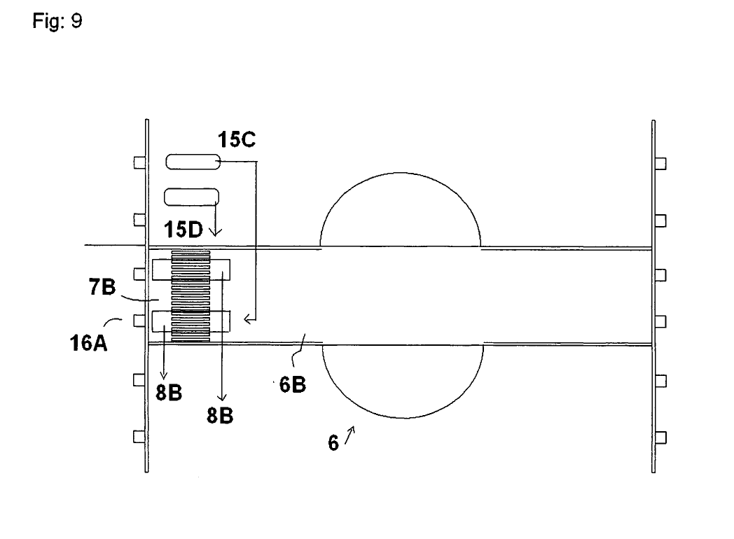

FIG. 10. Axle and Gear Wheel Connection—Rotation Method of Axel and Gear

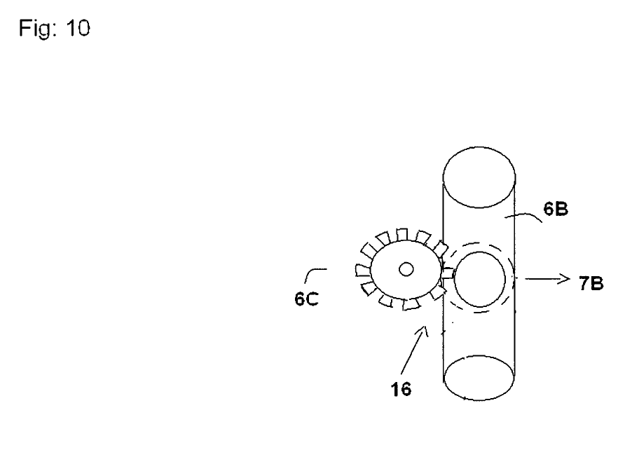

### DETAILS OF THE DRAWINGS

1. Positive Wire for electricity transfer
A. Fuse to avoid shortcut
2. Automatic flasher to connect and disconnect electricity
A. Positive entry
B. Negative entry
C. Electricity connected and disconnected
3. Terminal to divide electricity
4. Horn to warn the pedestrian
A. Right side reverse gear light
B. Left side reverse gear light
5. Gas Pedal to connect and disconnect Electricity
A. Negative wire
B. Hub to turn
C. Gears on the hub
D. Positive Wire
6. Differential
A. Second contact blinker (white)
B. Axel
C. Gear Wheel
7. Spring for up and down movement
A. Box
B. Grooves on the Axel
C. Gear Box
D. The wall underneath which has a cut for entry of gear wheel and lever
8. Pin
A. Gear wheel
B. Base to connect box control on the differential
9. Spring that has a plastic under it
A. The spring that has a plastic on it
10. Spring to move forward and backward
11. Lever
A. Plastic protrusion
B. The plastic protrusion the surface of which is metal and for connection to negative wire
12. Pipe edge which keeps the pipe in its place
13. Reverse gear light or Lamp
A. Direct light
B. Blinker
14. Body under the rear trunk
A. Outer pipe through which a negative passes
B. Inner pipe through which a negative wire passes
15. Battery to be used for its Electricity
A. Switch to connect and disconnect Electricity
B. Base for Installation
C. Control Box One
D. Control Box Two
16. Place of connection of gear wheel to axel for connection to the body and negative
A. Place to install disc and plate
B. Negative outlet
C. First contact which is ON. (white)
D. Base for keeping the First and Second Box Control

This design has no substitute.

What is claimed is:

1. All the work belongs to me.
All the work is done by only and only me and not anybody else.
I did all the work by myself alone.
I have no external source for what I have done.
